(19) United States
(12) Patent Application Publication
(10) Pub. No.: US 2004/0218687 A1
(43) Pub. Date: Nov. 4, 2004

(54) Ultra-wideband pulse modulation system and method

(76) Inventor: John Santhoff, San Diego, CA (US)

Correspondence Address: Mitchell P. Brook, Esq., Suite 200, 11988 EI Camino Real, San Diego, CA, 92130, US

(21) Appl. No.: 10/426,839

(22) Filed: Apr. 29, 2003

(51) Int. Cl. H04L 27/04

(52) U.S. Cl. 375/295

(57) ABSTRACT

An ultra-wideband pulse modulation system and method is provided. One method of the present invention includes a method of transmitting a plurality of ultra-wideband pulses, wherein each ultra-wideband pulse represents a data symbol. The modulation and pulse transmission method of the present invention enables the simultaneous coexistence of the ultra-wideband pulses with conventional carrier-wave signals. The present invention may be used in wireless and wired communication networks such as hybrid fiber-coax networks. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to ultra-wideband communications. More particularly, the invention concerns a method of modulating ultra-wideband pulses for wire and wireless communications.

### BACKGROUND OF THE INVENTION

The Information Age is upon us. Access to vast quantities of information through a variety of different communication systems are changing the way people work, entertain themselves, and communicate with each other. For example, as a result of increased telecommunications competition mapped out by Congress in the 1996 Telecommunications Reform Act, traditional cable television program providers have evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as movies-on-demand and video teleconferencing demand high data transmission rates. Another example is interactive video in homes and offices. Moreover, traffic across the Internet continues to increase, and with the introduction of new applications, such as the convergence of voice and Internet data, traffic will only increase at a faster rate. Consequently, carriers and service providers are overhauling the entire network infrastructure—including switches, routers, backbone, and the last mile (i.e., the local loop)—in an effort to provide more bandwidth.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. The need for more bandwidth is evidenced by user complaints of slow Internet access and dropped data links that are symptomatic of network overload.

Therefore, there exists a need for a method to increase the bandwidth of wired network or communication system, as well as a wireless network or communication system.

### SUMMARY OF THE INVENTION

The present invention provides a method of modulating an ultra-wideband (UWB) signal comprised of a plurality of UWB pulses. The UWB pulses can be transmitted and received wirelessly, or through any wire medium, whether the medium is twisted-pair wire, coaxial cable, fiber optic cable, or other types of wire media.

One embodiment of the present invention provides a UWB pulse modulation method that increases the available bandwidth of a communication system by enabling the simultaneous transmission of conventional carrier-wave signals and UWB pulses.

In one embodiment of the present invention, data symbols are modulated onto a plurality of UWB pulses, wherein each UWB pulse of electromagnetic energy represents one or more data symbols. The UWB pulses are then transmitted through a wired or wireless communications media. An UWB receiver receives the plurality of UWB pulses and demodulates the data.

One aspect of the invention is that unlike conventional ultra-wideband communications systems, each pulse represents at least one data symbol. The data symbol represents one or more binary digits, or bits.

The modulation and pulse transmission method of the present invention enables the simultaneous coexistence of the UWB pulses with conventional carrier-wave signals. The present invention may be used in wireless and wired communication networks such as hybrid fiber-coax networks.

By transmitting at least one data symbol with every UWB pulse, the average energy transmitted into the radio frequency spectrum is reduced, because less UWB pulses are transmitted. This reduces the possibility of interfering with other signals, and alternatively, in another embodiment of the present invention, may allow the power of each UWB pulse to be increased.

One feature of the present invention is that the transmitted UWB pulses have a spectral power density that does not cause interference with other communication signals.

Thus, the ultra-wideband pulses transmitted according to the methods of the present invention enable a significant increase in the bandwidth, or data rates of a communication system.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is an illustration of different communication methods;

FIG. 2 is an illustration of two ultra-wideband pulses;

FIG. 3 is an illustration of a conventional method of transmitting data symbols using multiple ultra-wideband pulses, and one method of transmitting data symbols using a single ultra-wideband pulse for each data symbol, according to the present invention;

FIG. 4 is an illustration of three ultra-wideband devices communicating using one method of the present invention; and

FIG. 5 is an illustration of an ultra-wideband communication system constructed according to the present invention.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a method of modulating a multiplicity of ultra-wideband pulses. The pulses can be transmitted and received wirelessly, or through any wire medium, whether the medium is twisted-pair wire, coaxial cable, fiber optic cable, or other types of wire media.

One embodiment of the present invention provides a pulse transmission method that increases the available bandwidth of a communication system by enabling the simultaneous transmission of conventional carrier-wave signals and ultra-wideband (UWB) pulses. One method includes transmitting at least one data symbol with every UWB pulse. The data symbol may represent one or more binary digits, or bits.

In contrast, conventional UWB communication systems transmit multiple UWB pulses to represent one data symbol. Thus, one feature of the present invention is that the average energy transmitted into the radio frequency (RF) spectrum is reduced. This reduces the possibility of interfering with conventional RF signals, and alternatively, in another embodiment of the present invention, may allow the power of each ultra-wideband pulse to be increased. Another feature of the present invention is that the transmitted ultra-wideband pulses can have a spectral power density that does not cause interference with conventional RF signals.

The modulation and UWB pulse transmission method of the present invention enables the simultaneous coexistence of the ultra-wideband pulses with conventional carrier-wave signals. The present invention may be used in wireless and wired communication networks such as hybrid fiber-coax networks.

Thus, the ultra-wideband pulses transmitted according to the methods of the present invention enable an increase in the bandwidth, or data rates of a communication system.

The present invention may be employed in any type of network, be it wireless, wired, or a mix of wire media and wireless components. That is, a network may use both wire media, such as coaxial cable, and wireless devices, such as satellites, or cellular antennas. As defined herein, a network is a group of points or nodes connected by communication paths. The communication paths may be connected by wires, or they may be wirelessly connected. A network as defined herein can interconnect with other networks and contain subnetworks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology in use on it, for example, a TCP/IP network, and a Systems Network Architecture network, among others. A network as defined herein can also be characterized by whether it carries voice, data, or both kinds of signals or data. A network as defined herein can also be characterized by who can use the network, for example, a public switched telephone network (PSTN), other types of public networks, and a private network (such as within a single room or home), among others. A network as defined herein can also be characterized by the usual nature of its connections, for example, a dial-up network, a switched network, a dedicated network, and a nonswitched network, among others. A network as defined herein can also be characterized by the types of physical links that it employs, for example, optical fiber, coaxial cable, a mix of both, unshielded twisted pair, and shielded twisted pair, among others.

The present invention may also be employed in any type of wireless network, such as a wireless PAN, LAN, MAN, WAN or WPAN. The present invention can be implemented in a “carrier free” architecture, which does not require the use of high frequency carrier generation hardware, carrier modulation hardware, stabilizers, frequency and phase discrimination hardware or other devices employed in conventional frequency domain communication systems. The present invention dramatically increases the bandwidth of conventional networks that employ wire media, but can be inexpensively deployed without extensive modification to the existing wire media network.

The present invention provides increased bandwidth by injecting, or otherwise super-imposing an ultra-wideband (UWB) signal, in the form of a multiplicity of pulses, into the existing data signal and subsequently recovers the UWB signal at an end node, set-top box, subscriber gateway, or other suitable location. Ultra-wideband, or impulse radio, employs pulses of electromagnetic energy that are emitted at nanosecond or picosecond intervals (generally tens of picoseconds to a few nanoseconds in duration). For this reason, ultra-wideband is often called “impulse radio.” That is, the UWB pulses may be transmitted without modulation onto a sine wave carrier frequency, in contrast with conventional radio frequency technology. Alternate implementations of UWB can be achieved by mixing the UWB pulses with a carrier wave that will control the center frequency of the resulting UWB signal. Ultra-wideband generally requires neither an assigned frequency nor a power amplifier.

Conventional radio frequency technology employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Cellular phone operators use 25 MHz of the allocated band to transmit cellular phone signals, and another 25 MHz of the allocated band to receive cellular phone signals.

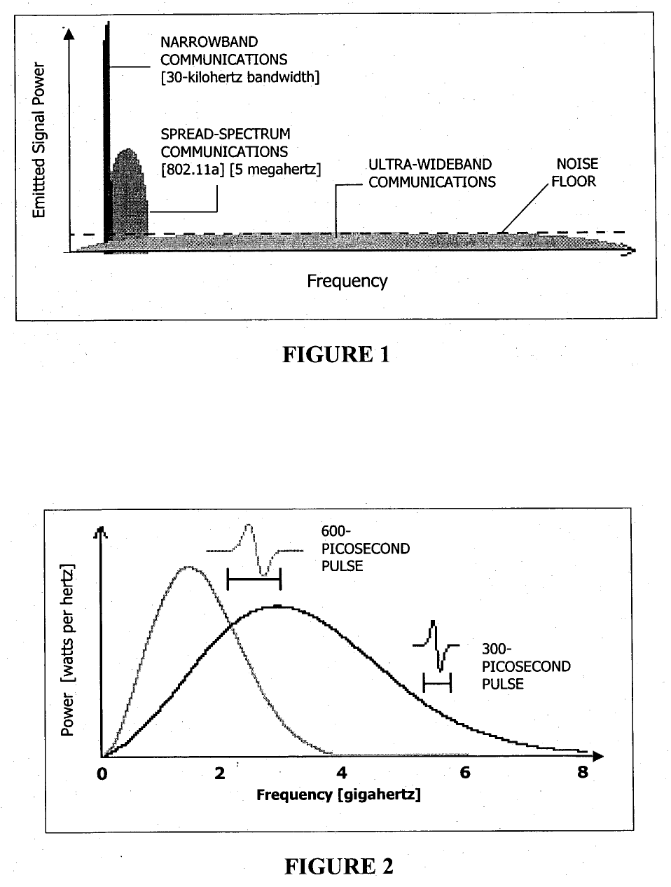

Another example of a conventional radio frequency technology is illustrated in FIG. 1. 802.11a, a wireless local area network (LAN) protocol, transmits radio frequency signals at a 5 GHz center frequency, with a radio frequency spread of about 5 MHz.

In contrast, a UWB pulse may have a 2.0 GHz center frequency, with a frequency spread of approximately 4 GHz, as shown in FIG. 2, which illustrates two typical UWB pulses. A UWB pulse is a single electromagnetic burst of energy. That is, a UWB pulse can be either a single positive burst of electromagnetic energy, or a single negative burst of electromagnetic energy. FIG. 2 illustrates that the narrower the UWB pulse in time, the broader the spread of its frequency spectrum. This is because bandwidth is inversely proportional to the time duration of the pulse. A 600 picosecond UWB pulse can have about a 1.6 GHz center frequency, with a frequency spread of approximately 1.6 GHz. And a 300 picosecond UWB pulse can have about a 3 GHz center frequency, with a frequency spread of approximately 3.2 GHz. Thus, UWB pulses generally do not operate within a specific frequency, as shown in FIG. 1. And because UWB pulses are spread across an extremely wide frequency range or bandwidth, UWB communication systems allow communications at very high data rates, such as 100 megabits per second or greater.

Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), which is referred to and incorporated herein in its entirety by this reference.

Also, because the UWB pulse is spread across an extremely wide frequency range, the power sampled at a single, or specific frequency is very low. For example, a UWB one-watt pulse of one nano-second duration spreads the one-watt over the entire frequency occupied by the UWB pulse. At any single frequency, such as at the carrier frequency of a CATV provider, the UWB pulse power present is one nano-watt (for a frequency band of 1 GHz). This is well within the noise floor of any wire media system and therefore does not interfere with the demodulation and recovery of the original CATV signals. Generally, the multiplicity of UWB pulses are transmitted at relatively low power (when sampled at a single, or specific frequency), for example, at less than −30 power decibels to −60 power decibels, which minimizes interference with conventional radio frequencies. However, UWB pulses transmitted through most wire media will not interfere with wireless radio frequency transmissions. Therefore, the power (sampled at a single frequency) of UWB pulses transmitted though wire media may range from about +30 dBm to about −140 dBm.

Generally, in some conventional ultra-wideband (UWB) modulation techniques, a doublet or wavelet “chip” is modulated by a data signal. The data signal imparts a phase to the chip. A “doublet” or “wavelet” in some instances is a positive UWB pulse followed by a negative UWB pulse, or vice-versa. The two UWB pulses comprise a single chip, which is the smallest element of data in a modulated signal. In this case, the chip, comprising two UWB pulses, represents a single bit of data (a 1 or a 0). If the data bit being sent is a 0, the chip may start with a positive UWB pulse and end with a negative UWB pulse, and if the data bit being sent is a 1, the chip may start with a negative UWB pulse and end with a UWB positive pulse.

For example, in a bi-phasic or antipodal system the two-pulse “wavelet or doublet” or its inverse (180° phase shift) represents a 1 or a 0. Other phase shifts may also be used such as 0°, 90°, 180°, and 270° shifts to develop quad-phasic systems.

However, one element common to these modulation techniques is that a 0, or 1, is represented by at least a positive and a negative pulse of energy. In the bi-phasic or antipodal system described above, a 0 is represented by two pulses of energy—a positive pulse and a negative pulse (or vice-versa). Thus, conventional modulation techniques use energy, in the form of at least two UWB pulses having a specific phase (positive or negative) to send each data bit. In the context of ultra-wideband (UWB) technology, which as described above, is capable of transmitting across wide radio frequency ranges, it is desirable to transmit by using the lowest possible energy, so as to avoid interfering with conventional radio frequency systems.

The present invention is distinct from the bi-phasic or antipodal systems mentioned above in that the data is not represented by a pulse doublet or wavelet. Instead, in one embodiment, a data symbol is represented by only a single ultra-wideband pulse, rather than by a pulse doublet or wavelet. The data symbol represents one or more binary digits, or bits. Thus, for each UWB pulse that is transmitted, the representation of at least one data bit is also transmitted.

One advantage of this embodiment is that the average energy used to transmit data is greatly reduced, which reduces the possibility of interfering with conventional radio frequency (RF) signals. This is because only one UWB pulse is used to transmit a data symbol, whereas conventional modulation methods use multiple pulses to transmit the same amount of data.

An alternative embodiment of the present invention may then transmit each UWB pulse at a higher power level, that may or may not attain the power level that would have been used without the modulation method of the present invention. By transmitting at a higher power level, the transmission range may be increased, while still avoiding any interference with conventional RF signals.

Multi-path interference can pose a significant problem in wireless communications systems. Multi-path is the result of portions of the transmitted signal arriving at the intended receiver through different propagation paths. The multi-path components are delayed in time due to their increased path length. A wireless receiver must be able to discriminate between intended signals and signals that arrive due to this multi-path effect. Since the receiver need only pay attention to signals that arrive in a small number of pre-determined time bins, multi-path components arriving at other times can be ignored. The present invention therefore provides an increase in multi-path immunity over other modulation techniques.

For example, given 25 time bins in a UWB pulse transmission frame using Pulse Position Modulation 16 (PPM 16), the receiver would need to accurately discriminate intended pulses from multi-path signals in 16 of the 25 time bins. In contrast, one embodiment of the present invention may place a single pulse of energy in one or two time bins of a pulse transmission frame containing 26 time bins. Energy arriving at the receiver in any of the remaining 24 time bins may then be ignored, greatly reducing any multi-path interference problems.

Generally, the amount of energy imparted into the RF spectrum is dependent on the number of pulses of electromagnetic energy sent within a given time frame. It is therefore advantageous to use a lower pulse transmission rate (PTRs), which are the number of ultra-wideband pulses sent per second. One drawback of lower PTRs is that the data rate is usually reduced. One feature of the present invention is that the PTR can be reduced without any reduction in data rate. This is because the representation of one data symbol can be sent with the transmission of every UWB pulse, as opposed to conventional methods, that transmit multiple UWB pulses to represent a single data symbol.

As mentioned, conventional ultra-wideband (UWB) transmission methods use multiple UWB pulses to represent a single data symbol. For example, a chip rate is selected, which is significantly larger than the bit rate. A chip is the smallest element of data in a modulated signal. The chip rate affects the amount of spectrum that is occupied. Conventional UWB transmission methods employ a chip rate that is significantly larger than the data rate. This can be represented as the chip-to-symbol ratio. The chip-to-symbol ratio can vary, but it is not uncommon for conventional UWB transmission methods to transmit 10 or more UWB pulses to represent a single symbol. In a method that uses 10 UWB pulses to transmit a single symbol, the time duration of a chip would be 1/10^{th} of the time duration of the symbol.

However, the transmission rate, or capacity of a system is limited by the chip-to symbol ratio. For example, a method employing a 500 MHz pulse transmission rate (PTR) that sends ten pulses per symbol, would have a data rate of 50 Mbps. Even with the addition of 8 level pulse amplitude modulation (PAM) encoding, the data rate would only rise to 150 Mbps. The capacity in this example is limited by the chip-to-symbol ratio of 10.

In the present invention the chip-to-symbol ratio is 1, enabling significantly higher data rates at the same average power. In this example, 500 million symbols would be sent per second, resulting in a data rate of 1.5 Gigabits. The present invention encodes data onto every single UWB pulse, so that each UWB pulse represents at least one data bit. A UWB pulse is a single burst of electromagnetic energy, having a duration that may range between) about 0.01 nanoseconds to about 1 millisecond.

In conventional UWB transmission methods, each UWB pulse, or in some instances pair of UWB pulses represents a single chip. The number of chips per symbol may vary but many conventional UWB transmission methods may send dozens or more chips to represent one symbol. That is, dozens of individual UWB pulses are transmitted to represent one symbol, which may represent only one data bit. This has significant disadvantages in that the complexity of the receiver is increased; there is more opportunity for multi-user interference; there is more opportunity for multi-path interference; there is a higher probability of inter-symbol interference; and the allowable transmission power must be spread across a number of UWB pulses.

Current FCC regulations impose strict power levels on the transmission of UWB pulses. Therefore, a conventional UWB transmission method that employs a plurality of UWB pulses to represent a single symbol must transmit each UWB pulse at a reduced power to avoid exceeding the mandated power levels. Generally, the receiver in these types of systems must combine energy from the plurality of UWB pulses in order to detect a single symbol. One approach used in a conventional UWB receiver is to employ a RAKE configuration. In this configuration the energy received from a number of UWB pulses is added together to achieve a detectable power level that allows the decoding of the data symbol. This adds additional complexity to the design of the receiver.

In addition, in a multi-user UWB environment each additional transmitting device increases the possibility of interference with other UWB devices. The transmission of UWB pulses intended for one UWB device may be received by another UWB device. Conventional UWB data transmission methods only exacerbate this problem by sending multiple UWB pulses for each symbol. In contrast, the present invention employs only a single UWB pulse to represent each symbol. This allows a smaller number of pulses to transmit the same amount of data. Thus, the potential for multi-user interference is reduced.

The present invention also minimizes another problem, multi-path interference. Multi-path interference in wireless communications systems stems from delayed signals arriving at a receiver through different paths. The delay is caused when the signal bounces off objects, arriving at the receiver from a different direction, or path. For example, each transmitted UWB pulse will have a component that travels directly to the receiver and other components that travel indirectly. The number of multi-path pulses increases linearly with the increased number of pulses transmitted. In the present invention, a fewer number of UWB pulses are transmitted, thereby reducing the number of multi-path components arriving at the receiver.

Another common problem minimized by the present invention is inter-symbol interference. Inter-Symbol Interference (ISI) occurs when energy from one UWB pulse is delayed or “smears” into the next UWB pulse. ISI can result in increased Bit-Error-Rates (BER) by making two adjacent UWB pulses indistinguishable. Increasing the spacing between UWB pulses reduces ISI. One drawback of increased spacing is the pulse transmission rate is reduced, thereby reducing the data symbol transmission rate. By transmitting a plurality of pulses to represent a single data symbol, conventional UWB communication methods will reach their allowable ISI limit at a significantly lower data rate. One embodiment of the present invention addresses the ISI issue without a reduction in the overall data rate by representing each data symbol with only one UWB pulse. The UWB pulses can then be sent at a significantly lower pulse transmission rate without compromising the data symbol rate. Alternatively, the UWB pulses, with each representing a data symbol, can be sent at a high data rate, increasing the number of data symbols sent, thereby increasing the data transmission rate.

Generally, the ability to establish reliable communications between two UWB devices in a wireless network is dependant on the receiver's ability to detect the UWB signal. Two factors, among others, are important to the reliability of a communication link between two UWB devices: the transmission power, and the distance between the communicating devices. With the average power limited by the current FCC regulations, a conventional system transmitting a plurality of UWB pulses for every symbol will have to divide the allowable energy across the plurality of UWB pulses. However, the ability of each UWB pulse to propagate through free space (and to a receiving device) is limited by its power.

Free space propagation loss (Lp), which is the loss of power with distance, can be calculated by the following:

$$L p = {[ \frac{λ}{4 π R} ]}^{2}$$

where λ is the wavelength of the signal, and R is the distance, in meters, between the transmitting device and receiving device. As distance increases between communicating devices, the power of the UWB pulses must also increase. When a UWB pulse signal is considered, λ is usually taken to be the speed of light divided by the center frequency of the UWB pulse. One embodiment of UWB pulses employed by the present invention may have a center frequency of about 5 GHz. Alternatively, other of UWB pulses having a range of center frequencies may be employed, such as UWB pulses having a center frequency from about 3.1 GHz center frequency to about 10.6 GHz center frequency. It will be appreciated that other UWB pulses, having different center frequencies can be employed by the present invention. Lp, in terms of power (in dB) can be calculated as:

$$L p = 20 Log [ \frac{λ}{4 π R} ]$$

Generally, a UWB receiver will have a minimum detectable power limit. That is, a UWB receiver will only detect signals that exceed a specific power. As discussed above, conventional UWB communication methods transmit a plurality of UWB pulses to represent a single data symbol. However, these plurality of UWB pulses must be transmitted at a lower power level, so as not to exceed the current FCC power limits. This limits the effective range of conventional UWB communication systems, because the energy of the low power UWB pulses quickly dissipates due to free space propagation losses.

In contrast, the present invention transmits UWB pulses at a significantly higher power and a lower pulse transmission rate. For example, to achieve the same average power, a system that transmits 10 pulses per symbol would have to limit the power in each pulse to 1/10^{th} of the power of a communication device employing the present invention. A distance comparison of these pulses shows that the device designed in accordance with the present invention would ensure detectable pulse amplitude at a distance \sqrt{10} or 3.16 times greater than the alternate system. This is due to the propagation loss in free space being proportional to the square of distance. Another comparison example is that if one embodiment of the present invention was configured to approximate the same average power of a 10-pulses-per-symbol system, the pulse transmission rate of the present invention would only be 1/10^{th} of the 10-pulses-per-symbol system.

Thus, a UWB communication system employing the UWB pulse modulation methods of the present invention achieves a greater detectable UWB pulse distance, and thus a greater communication range, for the same average power used by conventional communication methods.

In one embodiment of the present invention, every ultra-wideband pulse represents one data symbol that represents at least one data bit. A UWB pulse is a single burst of electromagnetic energy, having a duration that may range between about 0.01 nanoseconds to about 1 millisecond. Data is modulated onto the UWB pulse using any known modulation technique. By way of example and not limitation, the modulation technique may include one or more of the following: Pulse Amplitude Modulation (PAM), Pulse Position Modulation (PPM), Pulse Frequency Modulation (PFM), Pulse Width Modulation, On-Off keying (OOK), Sloped Amplitude Modulation (SLAM), Coded Recurrence Modulation (CRM), Ternary Modulation (TM), Binary Phase Shift Keying (BPSK), Quadrature Phase Shift Keying (QPSK), or any combination of the above modulation techniques. It will be appreciated that modulation techniques other than those listed above may be used in conjunction with the present invention.

In another embodiment of the present invention the width of the pulse may vary to provide additional power in the pulse to allow detection at greater distances. The pulse width is the time duration of the UWB pulse. The UWB pulse duration that may range between about 0.01 nanoseconds to about 1 millisecond.

Any type of data may be transmitted using the techniques and methods described herein. For example, the data transmitted across a UWB communications system constructed according to the present invention may comprise: a web page, a computer executable program, software, digitized voice, video, graphical images, text, and any other data of interest. It is anticipated that forms of data other than those listed herein may be transmitted in accordance with the present invention. It is additionally anticipated that the specific shape of the UWB pulse may take many forms that include uni-polar and bi-polar shapes.

Another embodiment of the present invention may reduce the pulse transmission rate, thereby allowing an increase in the power, or amplitude of the transmitted UWB pulses, in order to increase the range of the communication system. The current FCC power limitations limit the average power transmitted by a UWB system. By reducing the number of transmitted UWB pulses, the average power is reduced, thereby allowing an increase in the transmission power of the remaining UWB pulses. As discussed above, a UWB receiver will only detect signals that exceed a specific power, and the power of a UWB pulse is reduced by free space propagation losses. Therefore, one feature of a UWB communication system constructed according to the present invention is that the range of the system may be increased by increasing the power of each transmitted UWB pulse, while reducing the number of transmitted UWB pulses, thereby maintaining an average power level that complies with the current FCC requirements.

Yet another embodiment of the present invention may increase the UWB pulse width to provide more power per pulse to allow for detection of the UWB pulse at a greater distance. The pulse width is the time duration of the UWB pulse. The UWB pulse duration that may range between about 0.01 nanoseconds to about 1 millisecond.

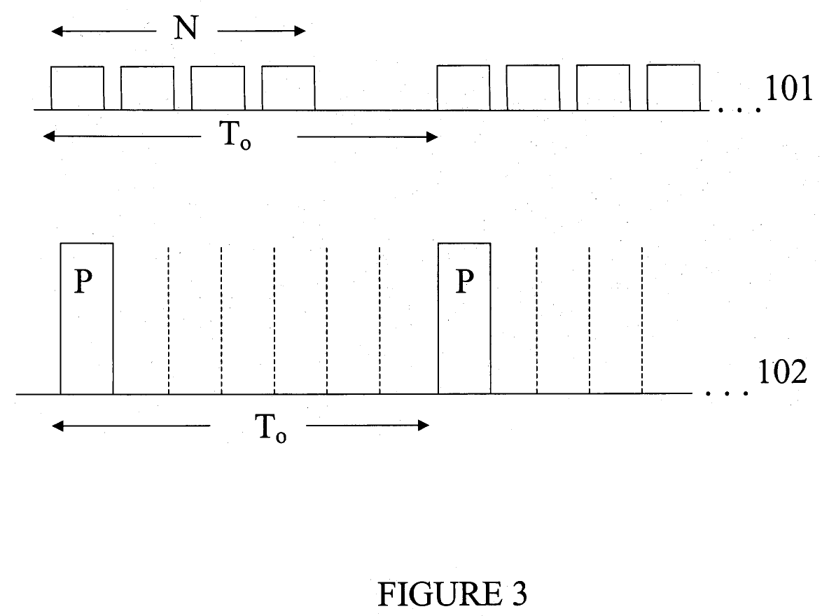

Referring now to FIG. 3, one embodiment of the present invention is illustrated. Time line 101 illustrates a conventional UWB communication method that transmits a plurality of N pulses to represent a single data symbol. The N pulses are transmitted within a time frame To. The time frame To may be comprised of any number of discrete time bins, with a UWB pulse located in any one of the discrete time bins. In this conventional method, the N pulses comprising a single data symbol are transmitted at a pulse transmission rate of

$$\frac{1}{T o} .$$

For example, 10 pulses may be transmitted within the time frame T₀. These 10 pulses will represent a single data symbol.

In contrast, a communication system constructed according to one embodiment of the present invention, illustrated as time line 102, will transmit a single ultra-wideband pulse P, that represents a single data symbol, at a pulse transmission rate of

$$\frac{1}{T o} .$$

That is, only one UWB pulse P, representing one data symbol, is sent in the time frame To. The pulse transmission rate is the number of ultra-wideband (UWB) pulses sent per second. For example, a pulse transmission rate of 100 MHz may be employed. Other pulse transmission rates, such as 200 MHz, 400 MHz, or other suitable pulse transmission rates may be employed.

However, as illustrated by the dashed lines in time line 102, each time frame T₀ includes multiple time bins. One feature of the present invention is that the same amount of data (carried by the data symbol) is transmitted using only one UWB pulse P, where conventional communication systems employ multiple pulses N. One feature of this aspect of the present invention, is that the task of receiving and decoding the data is now much easier. A receiver must only receive a single UWB pulse P per time frame T₀, which allows it to ignore any distracting energy that is present in other locations in the time frame T₀. This greatly minimizes problems associated with multi-path interference, inter-symbol interference and deciphering pulses in a multi-user UWB environment.

Another feature of the present invention is that the other time bins are available for other uses. In this embodiment, reflection appearing in any other time bin may be ignored. Alternatively, the UWB pulse may occupy another predetermined time bin to “whiten” the radio frequency (RF) spectrum. That is, the spectral peaks of the UWB pulses are reduced, thereby avoiding interference with conventional RF signals. In another embodiment, the UWB pulse may occupy a first time bin position allowing for a “guard time” before the next UWB pulse transmission frame, which increases the reliability, and decreases the bit-error-rate of UWB communication system employing the present invention.

One advantage of a “one-pulse” embodiment, that only transmits a single UWB pulse to represent a single data symbol, is that the average energy used to transmit data is reduced by at least 50%, which greatly reduces the possibility of interfering with conventional RF signals. An alternative embodiment of the present invention may then transmit the single UWB pulse at a higher power level, which may or may not attain the power level that would have been used without the modulation method of the present invention. By transmitting at a higher power level, the transmission range may be increased, while still avoiding any interference with conventional RF signals.

Thus, as described above, multiple data bits represented by a data symbol may be transmitted by a single UWB pulse. It will be appreciated that the method of UWB pulse modulation described above can also be employed with other modulation techniques, such as pulse amplitude modulation, to increase the number of data bits transmitted by a single UWB pulse. The number of data bits transmitted by a single UWB pulse may be 1, 2, 3, 4, or more.

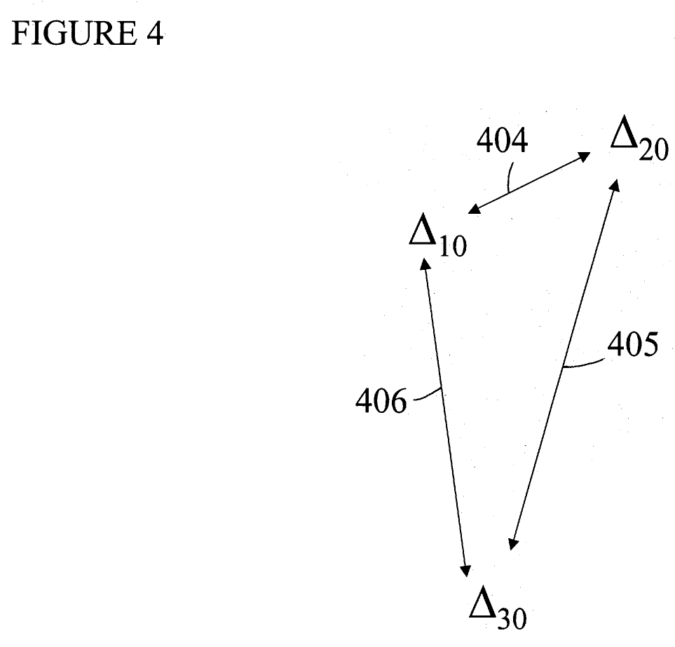

Referring now to FIG. 4, one method of practicing the present invention is illustrated. Ultra-wideband (UWB) devices 10, 20, 30 communicate through wireless links 404, 405, 406. The number of UWB devices 10, 20, 30 may decrease to two, or increase to any required number. The distance between any of the devices 10, 20, 30 may vary, which may require an adjustment to the UWB pulse transmission rate, as described above, to allow UWB pulses having increased power, or amplitude, to be transmitted between devices 10, 20, 30. Alternatively, or substantially simultaneously, the UWB pulse width may also be adjusted, as described above, to permit communications between the UWB devices 10, 20, 30 as the distance between them changes.

The UWB pulse modulation methods of the present invention may also be employed in the UWB communication apparatus and methods described in co-pending, non-provisional application Ser. No. 09/677,082, titled “COMMUNICATION SYSTEM,” which is referred to and incorporated herein in its entirety by this reference.

Thus, UWB pulse amplitudes, or pulse power, pulse widths, pulse transmission rates, and the data rate may each be adjusted to compensate for a change in distance between UWB devices 10, 20, 30, or a change in the number of communicating UWB device users in an area. A UWB device 10, 20, 30 may be a phone, a personal digital assistant, a portable computer, a laptop computer, any network as described above (LAN, WAN, PAN etc.), video monitors, computer monitors, or any other device employing UWB technology.

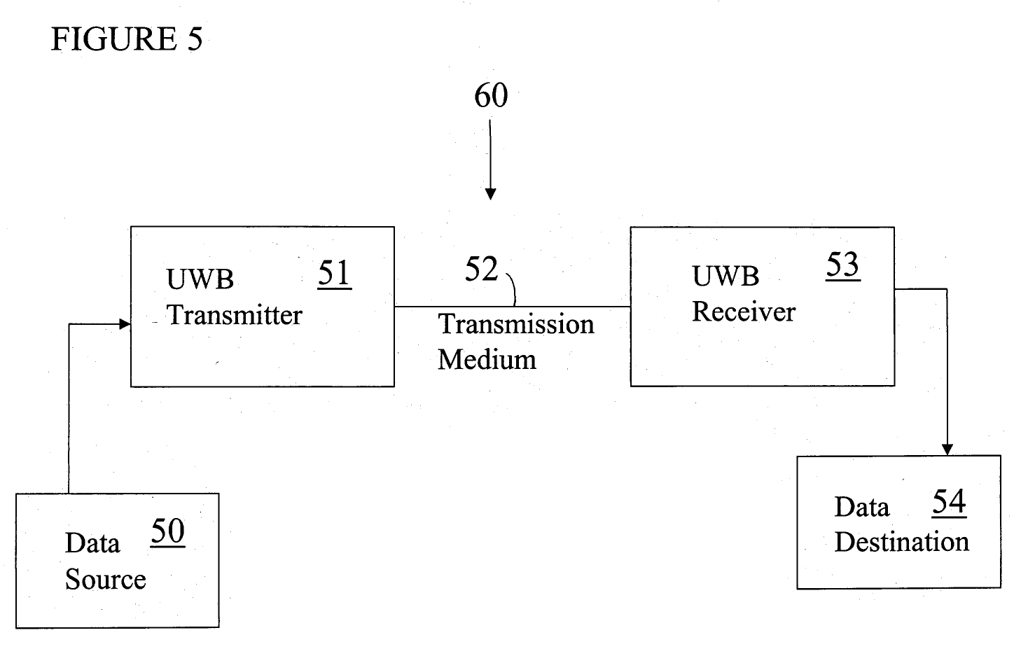

Referring now to FIG. 5, one embodiment of an ultra-wideband (UWB) communication system 60 constructed according to the present invention is illustrated. A data source 50 supplies data to the UWB transmitter 51. The data can be any type of data of interest, such as, among others, audio data, video data, computer executable programs, Internet data such as web pages, text, and graphical images. The UWB transmitter 51 modulates the data onto data symbols. The UWB transmitter 51 then transmits the data symbols, through transmission media 52, as UWB pulses, where each UWB pulse is representative of a single data symbol. The transmission media 52 can be either wireless or wire or may constitute a combination of wireless and wire media. The UWB receiver 53 is operatively coupled to the transmission media 52, and receives the UWB pulses. The UWB receiver demodulates the data from the received data symbols and forwards it to the data destination 54. The data destination 54 may be any device employing UWB technology, including, but not limited to, a phone, a personal digital assistant, a portable computer, a laptop computer, any network as described above (LAN, WAN, PAN etc.), video monitors, computer monitors, or any other suitable device.

The UWB communication system 60 may include several components, including a controller, digital signal processor, an analog coder/decoder, a waveform generator, an encoder, static and dynamic memory, data storage devices, a receiver, an amplifier, an interface, one or more devices for data access management, other necessary components, and associated cabling and electronics. One or more of the above-listed components may be co-located or they may be separate devices, and the UWB communication system 60 may include some, or all of these components, other necessary components, or their equivalents. Any one of the UWB communication system 60 devices, identified above, may include: error control; data compression functions; analog to digital conversion functions and vice versa; and various interface functions for interfacing to wire media such as phone lines and coaxial cables. Alternative embodiments of the UWB communication system 60 may employ hard-wired circuitry used in place of, or in combination with software instructions. Thus, embodiments of the UWB communication system 60 are not limited to any specific combination of hardware or software.

Thus, it is seen that an apparatus and method for modulating, and transmitting electromagnetic pulses, such as ultra-wideband pulses, is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the instant disclosure, and the present invention is limited only by the instant disclosure. It is noted that various equivalents for the particular embodiments discussed in this description may practice the invention as well.

What is claimed is:

1. A method of transmitting data, the method comprising the steps of:
transmitting a plurality of ultra-wideband pulses, wherein each ultra-wideband pulse represents a data symbol.

2. The method of claim 1, wherein each of the ultra-wideband pulses comprises a single burst of electromagnetic energy having a duration that may range between about 0.01 nanoseconds to about 1 millisecond.

3. The method of claim 1, wherein the data symbol comprises a representation of at least one binary digit.

4. The method of claim 1, further including the step of:
increasing an amplitude of each of the plurality of ultra-wideband pulses.

5. The method of claim 4, further including the step of:
decreasing a transmission rate of the increased amplitude ultra-wideband pulses.

6. The method of claim 1, further including the step of:
increasing a pulse width of each of the plurality of ultra-wideband pulses.

7. The method of claim 6, further including the step of:
decreasing a transmission rate of the increased pulse width ultra-wideband pulses.

8. The method of claim 1, further including the steps of:
increasing an amplitude of each of the plurality of ultra-wideband pulses; and
increasing a pulse width of each of the plurality of ultra-wideband pulses.

9. The method of claim 8, further including the step of:
decreasing a transmission rate of the increased amplitude and increased pulse width ultra-wideband pulses.

10. The method of claim 1, further including the step of:
modulating the data onto the data symbol using at least one modulation technique selected from a group consisting of: pulse amplitude modulation, pulse frequency modulation, pulse position modulation, pulse width modulation, binary phase shift keying, quadrature phase shift keying, on-off keying, sloped amplitude modulation, coded recurrence modulation, and ternary modulation.

11. The method of claim 1, wherein the data is selected from a group consisting of: an Internet page, a computer executable program, a computer executable code, digitized voice, a video, an image, and text.

12. The method of claim 1, wherein each of the ultra-wideband pulses comprises an impulse radio signal.

13. The method of claim 1, wherein the plurality of ultra-wideband pulses are transmitted at a transmission rate selected from a group consisting of: a fixed pulse transmission rate, a pseudorandom pulse transmission rate, and a variable pulse transmission rate.

14. The method of claim 1, wherein each of the ultra-wideband pulses comprises an impulse radio signal.

15. A computer program product for directing a general purpose digital computer to perform method steps to communicate data, the method steps comprising:
transmitting a plurality of ultra-wideband pulses, wherein each ultra-wideband pulse represents a data symbol.

16. The computer program product of claim 15, wherein the method step of transmitting a plurality of ultra-wideband pulses, with each ultra-wideband pulse representing a data symbol, is translated into a physical implementation.

17. The computer program product of claim 16, wherein the physical implementation is selected from a group consisting of: a field-programmable gate array and an application specific integrated circuit.

18. An apparatus including the computer program product of claim 15.

19. The computer program product of claim 16, wherein the physical implementation is selected from a group consisting of: object code, and source code.

20. A method of transmitting data, the method comprising the steps of:
means for transmitting a plurality of ultra-wideband pulses, wherein each ultra-wideband pulse represents a data symbol.

21. An ultra-wideband communication system, comprising:
a transmitter structured to transmit a plurality of ultra-wideband pulses wherein each ultra-wideband pulse is representative of a data symbol; and
a receiver structured to receive the plurality of ultra-wideband pulses.

22. The ultra-wideband communication system of claim 21, wherein each of the ultra-wideband pulses comprises a single burst of electromagnetic energy having a duration that may range between about 0.01 nanoseconds to about 1 millisecond.

23. The ultra-wideband communication system of claim 21, wherein each of the ultra-wideband pulses comprises an impulse radio signal.

24. The ultra-wideband communication system of claim 21, wherein the data symbol comprises a representation of at least one binary digit.

25. The ultra-wideband communication system of claim 21, wherein the transmitter modulates the data onto the data symbol using at least one modulation technique selected from a group consisting of: pulse amplitude modulation, pulse frequency modulation, pulse position modulation, pulse width modulation, binary phase shift keying, quadrature phase shift keying, on-off keying, sloped amplitude modulation, coded recurrence modulation, and ternary modulation.

26. The ultra-wideband communication system of claim 21, wherein the ultra-wideband communication system includes a wireless communication medium.

27. The ultra-wideband communication system of claim 21, wherein the ultra-wideband communication system includes a substantially continuous wire medium.

28. The ultra-wideband communication system of claim 21, wherein the substantially continuous wired medium is selected from a group consisting of: an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.

29. The ultra-wideband communication system of claim 21, wherein the substantially continuous wired medium is selected from a group consisting of: a power line, an optical network, a cable television network, a community antenna television network, a community access television network, a hybrid fiber coax system network, a public switched telephone work, a wide area network, a local area network, a metropolitan area network, a TCP/IP work, a dial-up network, a switched network, a dedicated network, a non-switched work, a public network and a private network.

30. An ultra-wideband communication system, comprising:
means for transmitting a plurality of ultra-wideband pulses wherein each ultra-wideband pulse is representative of a data symbol; and
means for receiving the plurality of ultra-wideband pulses.
